(19) United States
(12) Patent Application Publication
(10) Pub. No.: US 2023/0271732 A1
(43) Pub. Date: Aug. 31, 2023

(54) HYBRID DRONE FOR LANDING ON VERTICAL STRUCTURES

(71) Applicant: HW AVIATION AG, Ruggell (LI)

(72) Inventor: Herbert Weirather, Eschen (LI)

(21) Appl. No.: 18/014,698

(22) PCT Filed: Jul. 10, 2020
(86) PCT No.: PCT/EP2020/069475

§ 371 Date: Jan. 5, 2023

(51) Int. Cl. B64U 10/25; B64U 70/99; B64C 5/08; B64U 70/80; G05D 1/08

(52) U.S. Cl. CPC B64U 10/25; B64U 70/99; B64C 5/08; B64U 70/80; G05D 1/0808; B64U 2101/60

(57) ABSTRACT

The invention relates to a hybrid drone for transporting or delivering objects 124, comprising at least one first wing 102 having an airfoil, at least one first and one second longitudinal drive unit 104, wherein the first longitudinal drive unit 104 and the second longitudinal drive unit 104 are arranged on the at least one wing 102, an object-holding device 110 formed on an upper side or on an underside between the first and second longitudinal drive units 104 and for holding an object 124, and a regulating unit formed for regulating the hybrid drone, in particular the drive units, based on control signals. The hybrid drone further comprises at least one first high drive unit 105, wherein the first high drive unit 105 is aligned or is pivotally alignable such that a thrust force that can be generated by means of the high drive unit 105 acts substantially orthogonally to the longitudinal direction 106 and substantially parallel to a vertical axis 116 of the hybrid drone, and the first high drive unit 105 is arranged with a defined lever distance relative to the center of gravity of the hybrid drone, and wherein a pitch angle of the hybrid drone in the flight state is adjustable by means of the first high drive unit 105. In addition, at least one holding element is provided, which is associated with the underside in a front region of the hybrid drone, wherein the holding element is configured for releasably arranging, in particular for hooking, the hybrid drone on a top-ending vertical receiving structure.

### FIELD OF THE INVENTION

The present invention relates to a hybrid unmanned aerial vehicle (UAV) having a unique drive unit arrangement that allows the hybrid to hover upright, land on vertical structures, cling to vertically terminating structures, and drop objects there.

### BACKGROUND OF THE INVENTION

Drones are known from the prior art for delivering parcels. The major advantages for parcel delivery with drones are obvious. First and foremost, they are enormously fast. Drones can fly the direct route, do not have to constantly slow down and accelerate, do not get stuck in traffic jams and are very energy efficient. All drone concepts are very environmentally friendly compared to car delivery, as they fly electrically, emit no CO₂, soot particle's or toxic gases, have no rubber abrasion, and most importantly do not need or even relieve polluting roads. Drones not only drastically reduce the delivery time, but also minimize the costs on the part of the delivering companies, since less personnel is needed.

Multicopter drones can be positioned in space with almost no restrictions. There are known parcel delivery multicopters that rope down a parcel at the recipient while they are above the drop-off point. This solution poses safety risks. For example, dogs can attack the lowering package or grab the rope and cause the drone to crash.

In addition to multicopter drones, there are also the so-called hybrid unmanned aerial vehicles—which have an airfoil. The advantage of this classic aircraft form is the range, because significantly less energy is required for the lift with the wing, in contrast to the multicopter, which must permanently generate the lift via the rotors. Thus, a hybrid drone basically combines the advantages of a multicopter and an airplane.

In addition, drones are known to deliver packages, dropping the package with a small parachute at the height of a landing zone.

In the examples given, only open spaces, gardens or flat roofs are suitable as storage locations, although very few people have such storage locations. People living in the city can only be supplied if the roof is also accessible. In addition, third persons could easily gain access to the dropped or roped-off package.

### OBJECT OF THE INVENTION

It is therefore an object of the present invention to provide a drone that allows both the advantage of a comparatively large range and an improved, in particular more flexible and safe, delivery of an object.

This object is solved by the realization of the characterizing features of the independent claims. Features which further develop the invention in an alternative or advantageous manner are to be taken from the dependent claims.

The invention relates to a hybrid drone designed to cover long distances in a cruise flight on the one hand and to and on a vertical structure, e.g. wall, on the other hand.

The hybrid drone according to the invention can perform a stable vertical (upright) hovering flight with or without an additional object in order to land at a vertical structure, to adhere to vertical structures, to grip upward-ending vertical structures, and/or to drop objects there. In addition to efficient cruise flight, this additionally solves the problem of flying very maneuverable maneuvers, allowing the hybrid drone to approach very narrow urban canyons in order to land on those vertical structures.

None of the known hybrid drones are capable of landing on a vertical wall.

The hybrid drone according to the invention, which can reliably perform a landing on a vertical structure, provides the following characteristics: The center of gravity, when landed, is not far from the vertical structure to avoid large leverage effects; the object to be transported can be reached from above (or from above a railing); and there is a large holding force between the drone and the vertical structure.

### SUMMARY OF THE INVENTION

The invention relates to a hybrid drone for transporting or delivering objects, comprising at least one first wing having an airfoil, in particular with a wing control surface, wherein a drone-own transverse axis is defined by the extension of the at least one wing, and at least one first and one second longitudinal drive unit, wherein the first longitudinal drive unit and the second longitudinal drive unit are arranged on the at least one wing, and the first and the second longitudinal drive unit are each aligned or pivotally alignable such that a thrust force that can be generated by means of the respective longitudinal drive unit acts parallel to a longitudinal direction of the hybrid drone, wherein the longitudinal direction is orthogonal to the transverse axis and directed substantially in a forward flight direction defined by the hybrid drone.

The hybrid drone further comprises an object-holding device formed on an upper side or on a lower side between the first and the second longitudinal drive units and for holding an object, wherein the lower side of the hybrid drone is below the at least one wing and the upper side is above the at least one wing (along the vertical axis of the drone). Furthermore, a regulating unit is provided, which is configured to regulate the hybrid drone, in particular the drive units, based on control signals.

The hybrid drone has at least one first high drive unit, wherein the first high drive unit is aligned or can be pivotally aligned in such a way that a thrust force which can be generated by means of the high drive unit acts substantially orthogonally to the longitudinal direction and substantially parallel to a vertical axis of the hybrid drone, and the first high drive unit is arranged with a defined lever spacing relative to the center of gravity of the hybrid drone. By means of the first high drive unit, a pitch angle of the hybrid drone in the flight state is adjustable.

The hybrid drone has at least one holding element, in particular a hook or eye, which is associated with the underside in a front region of the hybrid drone, wherein the holding element is designed for releasably arranging, in particular for hooking, the hybrid drone on a top-ending vertical receiving structure.

The hybrid drone may further comprise a holding element disposed on the at least one wing, or the hybrid drone may comprise a fuselage part and the holding element is disposed on the fuselage part.

The holding element may further comprise an opening in a holding direction opposite to the longitudinal direction, in particular wherein the holding element comprises a rearwardly protruding structure accessible from the rear.

The holding element can be fixedly mounted or extendable and/or designed to be retractable, in particular into the at least one wing or the fuselage part.

The holding element may be configured to generate a holding force by pressing the hybrid drone against the vertical structure, in particular by partially retracting the holding element.

The hybrid drone may include a counter element extendable at the bottom for applying a clamping force between the holding element and the counter element.

The hybrid drone may include at least one tail fin having tail control surfaces 108, wherein the tail fin is disposed above the at least one wing and behind the wing by a support element connected to the at least one wing 102, in particular the fuselage part, and wherein the at least one tail fin is disposed in an airflow that may be generated by the first and/or second longitudinal drive units.

The hybrid drone can have at least one second high drive unit, wherein the second high drive unit is aligned or pivotably alignable in such a way that a thrust force which can be generated by means of the high drive unit acts substantially parallel to the vertical axis and the second high drive unit is mounted with a defined lever spacing relative to the center of gravity of the hybrid drone, and wherein a pitch angle and a roll angle of the hybrid drone in the flight state are adjustable by means of the second high drive unit.

A rolling motion can be controlled by the hybrid UAV in slow flight by means of differential control of the tail control surfaces and/or by means of differential control of the first and the second high drive units.

At least the first high drive unit may be pivotable about a pivot axis, wherein the pivot axis extends substantially orthogonally to the longitudinal direction and substantially orthogonally to the transverse axis.

The at least first high drive unit may be mounted on a pivotable or extendable arm and may be retractable into the at least one wing, or in particular into the fuselage part.

The object-holding device may include a conveyor system configured to convey an object received by the object-holding device forward or rearward, particularly to convey the object forward or rearward of the wing and eject it forward or rearward of the wing or to chance the center of gravity during a flight.

At least one of the longitudinal drive units and/or the at least one first high drive unit may comprise an electrically driven motor and propeller and/or enclosed propeller, in particular impeller.

At least one of the longitudinal drive units and/or the at least one first high drive unit can be designed and/or controllable for thrust reversal by changing the direction of rotation or by blade pitch.

The hybrid drone may include third and fourth longitudinal drive units, wherein the third is arranged coaxially to the first longitudinal drive unit and the fourth coaxially to the second longitudinal drive unit.

The hybrid drone may include an adhesive strip on the underside of the hybrid drone for establishing a releasable adhesive connection with a mating adhesive element disposed on the vertical receiving structure.

The hybrid drone may have a detection system, in particular camera, lidar, or radar, that is configured to perform object detection, wherein the regulating unit is configured to control the hybrid drone based on the object detection.

The hybrid drone can have an object release device having at least two release elements, in particular ropes or cables, that can be connected to the object, wherein the release elements have a distance of at least 10 cm.

The hybrid drone may comprise a control unit that has a release functionality, in the execution of which control of the object release device and/or the drive units takes place in such a way that the object is set into a defined pendulum or swinging movement and a targeted setting down of the object takes place at a specific point of the pendulum or swinging movement.

The hybrid drone may comprise a sensor for detecting a distance between the hybrid drone and the vertical receiving structure, particularly wherein the sensor is disposed on the underside.

The invention further relates to a flight method for a hybrid drone according to the invention for placing the hybrid drone, which is in a cruise flight state, into a hovering flight state, wherein a main direction of movement of the hybrid drone in the cruise flight state corresponds to a horizontal direction, a main lift is generated by flowing around the at least one first wing, and the longitudinal drive units generate a forward thrust in the longitudinal direction, comprising the steps of:
initiating a descent by a forward pitch of the hybrid drone,
reducing or terminating the forward thrust of the longitudinal drive units 104, in particular generating a thrust reversal, to reduce the speed of movement of the hybrid drone,
generating a thrust force substantially orthogonal to the longitudinal direction by means of the high drive unit for initiating, accelerating or decelerating a pitching motion of the hybrid drone in such a way that the hybrid drone is displaced into a substantially vertical orientation, in particular the longitudinal direction is oriented substantially vertically, and
when reaching vertical orientation
   such a regulated adjustment of the forward thrust in the longitudinal direction depending on a total weight of the hybrid drone, in particular taking into account a transported object, that the speed of movement of the hybrid drone in the longitudinal direction is substantially 0, and
   a continuous regulation, in particular holding, of the vertical orientation of the hybrid drone by means of regulation of the high drive unit, so that the hybrid drone is provided in the hovering flight state.

A detection and recognition, in particular by means of image processing, lidar or radar, of a vertical receiving structure and initiation of the reduction or termination of the forward thrust depending on the recognition of the vertical receiving structure may be applied in the flight method.

Furthermore, a landing method for setting down an object transported by the hybrid drone after performing the above flight method into a hovering flight may include the steps of:
approaching the hybrid drone to a top-ending vertical receiving structure by generating a pitching movement of the hybrid drone, in particular setting a defined angle of the longitudinal direction relative to the vertical, and thereby generating a relative movement of the hybrid drone in the direction towards the vertical receiving structure,
providing a contact of hybrid drone and vertical receiving structure through the continuous approach,
ascending the hybrid drone along the vertical receiving structure until at least the holding element is provided in the vertical direction above the upper end of the vertical receiving structure,
aligning the holding element such that a part of the holding element designed for releasable arrangement is present above the top-ending vertical receiving structure, and
arranging, in particular hooking, the hybrid drone to the vertical receiving structure by lowering the hybrid drone by reducing the forward thrust in the longitudinal direction 106 while maintaining contact with the vertical receiving structure.

In addition, during the landing method, the holding element can be aligned by means of extending the holding element and/or by means of pitching the drone in the direction of the vertical receiving structure.

Furthermore, during the landing method when arranging the hybrid drone, a clamping force can be generated by partially retracting the holding element or generating a counterforce.

Furthermore, during the landing method, unloading of the object can be performed by conveying the object over the upper end of the vertical receiving structure.

Detection and recognition, in particular by means of image processing, lidar or radar, of the vertical receiving structure and the approach and/or arrangement of the hybrid drone depending on the recognition of the vertical receiving structure can take place during the landing method.

The invention also relates to a launch method for a hybrid drone according to the invention for placing a hybrid drone, which is in a horizontal orientation and rests on its underside, in a cruise flight state, comprising the steps of:
generating a thrust force substantially parallel to the vertical axis, in particular by means of the high drive unit, thereby causing the hybrid drone to straighten toward a vertical orientation of the longitudinal direction,
especially balancing the hybrid drone in the vertical orientation,
generating a thrust force in the longitudinal direction, in particular by means of the longitudinal drive units, causing the hybrid drone to take off,
regulating the thrust force in the longitudinal direction in such a way that the hybrid drone is put into a climbing flight, and
generating a pitching motion of the hybrid drone upon reaching a certain altitude and shifting the hybrid drone from the climbing flight to the substantially, horizontal cruise flight state.

The invention also relates to a launch method for a hybrid drone according to the invention for placing a hybrid drone, which is in a vertical orientation and arranged at the top-ending vertical receiving structure, in a cruise flight state, comprising the steps of:
detaching the hybrid drone from the vertical support structure by generating a thrust force in the longitudinal direction, in particular by means of the longitudinal drive units.
generating a thrust force substantially orthogonally to the longitudinal direction, in particular by means of the high drive unit, causing tilting, in particular pitching, of the hybrid drone in the direction away from the vertical receiving structure,
regulating the thrust force in the longitudinal direction and the thrust force substantially orthogonally to the longitudinal direction such that the hybrid drone is provided in a hovering flight state with a horizontal direction of movement away from the vertical receiving structure,
increasing the thrust force in the longitudinal direction when reaching a certain distance from the vertical support structure,
regulating the thrust force in the longitudinal direction in such a way that the hybrid drone is put into a climbing flight, and
generating a pitching motion of the hybrid drone upon reaching a certain altitude and shifting the hybrid drone from the climbing flight to the substantially horizontal cruise flight state.

The at least one high drive unit can be retracted after reaching the cruise flight state.

Before the thrust force is increased, the thrust force, which is substantially orthogonal to the longitudinal direction, can be changed in the longitudinal direction, in particular by reducing the thrust force or reversing the thrust of the high drive unit, which causes the hybrid drone to tilt back.

The invention further includes a vertical launching and landing device for a hybrid drone according to the invention, in particular which includes an adhesive strip, wherein the launching and landing device comprises the following elements:
an attachment device adapted to attach the launching and landing device to a structure in a substantially vertical orientation, particularly to a vertical side of the structure,
at least one conveyor drive and
at least two contact and guide elements, which are formed parallel to each other with a certain distance, wherein
   each of the contact and guide elements comprises a mating adhesive element for establishing a releasable adhesive connection with the adhesive element of the hybrid drone, and
   the mating adhesive elements are designed in the form of a belt and can be driven in rotation by means of the conveyor drive, in particular in the form of a conveyor belt, in such a way that a hybrid drone in adhesive connection can be moved in a controlled manner along the contact and guide elements.

The launching and landing device can have two conveyor drives, wherein each of the mating adhesive elements can be driven individually by means of one of the conveyor drives in each case, and a hybrid drone in adhesive connection can be aligned with respect to its horizontal orientation by differential driving of the mating adhesive elements.

The mating adhesive elements can be Velcro strips.

The launching and landing device may comprise at least one repelling element for repelling a drone arranged at the launching and landing device, in particular for creating or increasing a distance between the adhesive element of the hybrid drone and the mating adhesive element.

The invention further relates to a dropping method for a hybrid drone according to the invention, which includes the following steps:
hovering the hybrid drone over a specific drop location,
dropping of an object connected to the object release device,
rotating the object in a certain direction, especially in the current wind direction, during the release,
moving the object into a defined position, in particular into a position parallel to the ground, in particular a horizontal position, and
releasing the connection between the object and the of release device when it touches the ground or reaches a certain distance from the ground.

### FURTHER ASPECTS OF THE INVENTION

The drone can also perform a completely silent landing approach, in which the drive units of the drone can be turned off for noise control. If there is enough space in the approach area and the vertical structure to be landed on is high enough above other obstacles, the drone can fly a trajectory similar to that of a larding bird, accordingly a kind of intercept arc that the drone temporarily descends so low that it is below the vertical structure to be landed on. The drone is then steered to rise again, ultimately nudging or landing at an upright angle against the vertical structure, at which point the drone has almost no kinetic energy left and sinks down. The extended hook can then hook onto the vertical structure ending at the top.

Taking into account many factors such as package weight, package size, wind speed, wind direction, temperature, altitude, etc., the flight path to landing is calculated so that the momentum, i.e. in particular the kinetic energy in the vertical direction, is released exactly when the drone is just above the top of the vertical structure. In this case, the energy of the drone flying forward is sufficient without switching on the drive units again. In this case, the drone lands silently,

Shortly before the drone lands, the person who is to receive the object can be informed to take caution via a personal message, such as “Please stand back, the drone is approaching.”

The drone's transport system is aligned so that an object to be delivered can also be dropped by parachute during the cruise flight. In this case, the parachute is opened and at the same time or with a time delay, the object-holding device releases the connection to the object. Due to the high forward speed and the braking effect of the parachute, the hybrid drone and the object separate very quickly,

Due to its ability to perform a very fast turning maneuver, the drone is also capable of dropping objects very quickly and efficiently. The drone flies at a flat approach angle with the drive units switched off to a position to be delivered and performs a tight and fast turning maneuver. Directly after that, the release of the object can start. This significantly reduces the duration of noise emission, especially compared to multicopters, which are already audible for the entire duration of the approach.

The drone can be secured and charged on the wall at the customer's premises, which is why a costly logistics center for regularly storing the drones is not absolutely necessary, These “parking spaces” at customers' premises can also be viewed as a decentralized network. This means that the drone can also fly directly to another customer on call, where a parcel needs to be picked up, for example.

When the term “above” is used, it refers to the orientation of the drone along the vertical axis. If the term “behind”, “rear”, “in front of” or “front” is used, this additionally refers to the longitudinal direction of the drone. When the term “right” or “left” is used, it refers to the transverse axis as viewed in the longitudinal direction. When the term “tilt” is used, it refers to a rotation around the transverse axis. When the term “slew” is used, it refers especially to a rotation around any axis of the drone and does not necessarily have to be around a vertical axis. In ordinary forward flight, the wing is oriented so that its airfoil generates lift.

### BRIEF DESCRIPTION OF THE DRAWINGS

Further advantages of the present invention are apparent from the detailed description and drawings.

FIG. 1a shows an embodiment of a hybrid drone according to the invention;

FIG. 1b shows the side view of a hybrid drone according to the invention hooked to a vertical structure;

FIG. 1c shows a drop of an object using a parachute of the hybrid drone of the invention in cruise flight;

FIG. 1d shows a descent/drop of an object of the hybrid drone of the invention in hovering flight;

FIG. 2 shows another embodiment of a hybrid drone according to the invention;

FIG. 3 shows a side view of a further embodiment of a hybrid drone according to the invention;

FIG. 4a shows a launching and landing station for a hybrid drone according to the invention;

FIG. 4b shows a hybrid drone of the invention adhering to the launching and landing station;

FIG. 4c shows a hybrid drone of the invention adhering to and aligned with the launching and landing station;

FIG. 5 shows an exemplary flight method of a rapid transition from cruise flight to erect hovering flight with a hybrid drone according to the invention;

FIG. 6 shows an example of a hybrid drone with differential thrust control;

FIG. 7 shows an example of a hybrid drone with collective thrust control;

FIG. 8 shows an example of a hybrid drone with a dual system; and

FIG. 9 shows an example of a hybrid drone with a tilt-wing.

### DETAILED DESCRIPTION

Exemplary methods and systems are described. The word “exemplary” is to be interpreted “as an example, instance or illustration.” Any embodiment or property described herein as “exemplary” or “illustrative” is not necessarily to be construed as preferred or advantageous over other embodiments or features. The embodiments described herein are not intended to be limiting. It is understood that certain aspects of the disclosed systems and methods may be arranged and combined in a variety of different configurations, all of which are contemplated herein.

Exemplary embodiments may relate to and/or be implemented in a system in which hybrid unmanned aerial vehicles, and in particular “hybrid unmanned aerial vehicles” (hybrid UAVs) or also referred to as a hybrid drone, which has at least one wing 102 that can be used to generate lift efficiently in cruse flight, and further has different propulsion configurations to be able to perform stable hovering flight. The hybrid drone according to the invention can perform landings on a vertical structure and transport and optionally deliver an object to the vertical structure. In this process, the drone can be assisted by a launching and landing station mounted on the vertical structure, or the drone can attach itself to top-ending vertical structures.

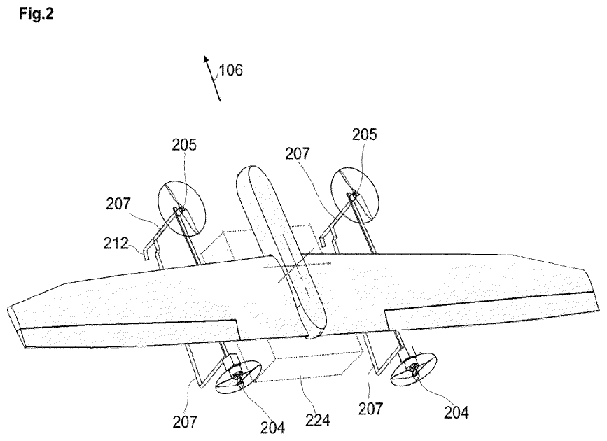

In addition to efficient horizontal cruise flight, the exemplary embodiments can transition very quickly to hovering flight as well as hover in place in a controlled manner or slowly approach vertical structures. The exemplary embodiments have a holding element, in particular formed as a hook 112, and/or an adhesive strip 321. FIG. 2 illustrates another position of a hook 212. Many other embodiments are possible for holding onto a vertical structure.

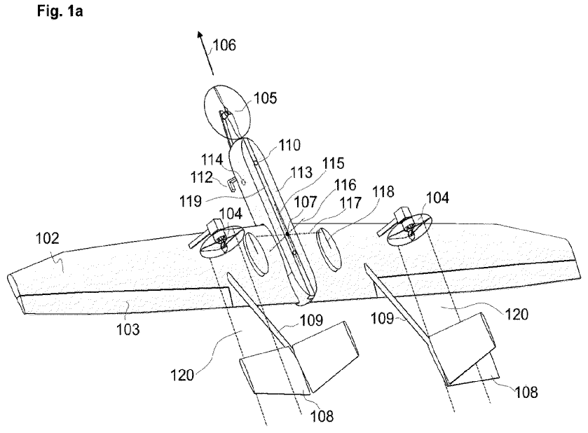

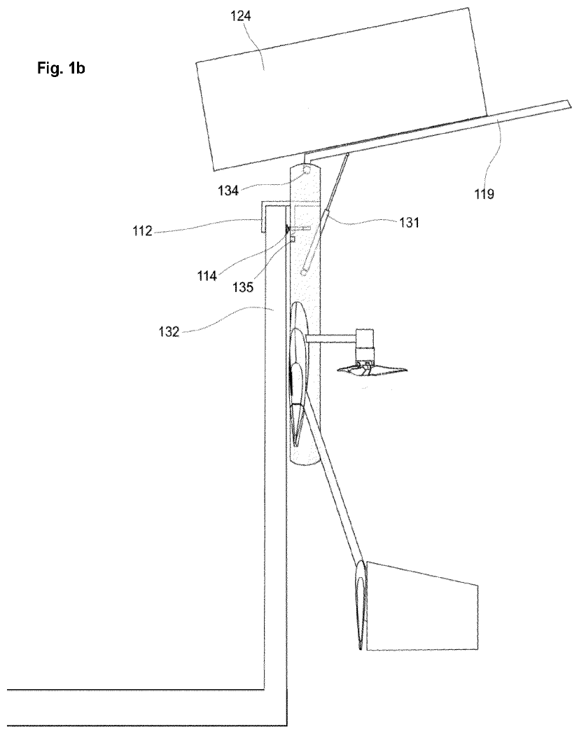

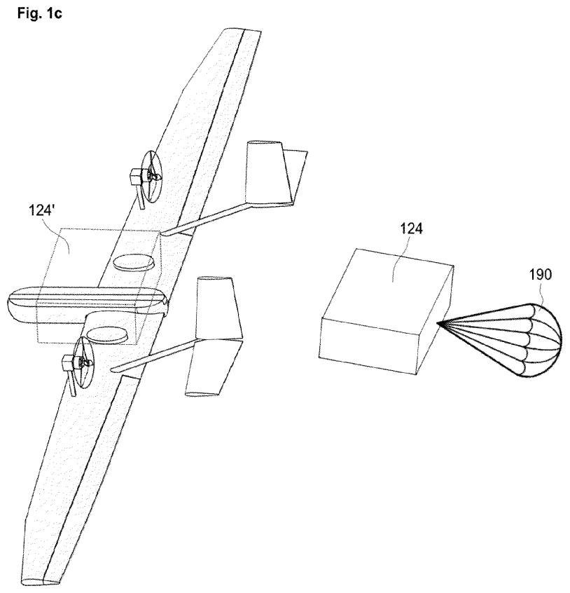

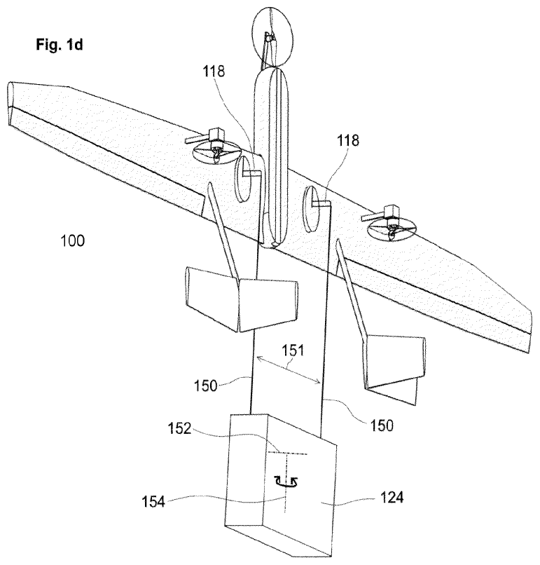

FIG. 1a shows an example of two longitudinal drive units 104 in the form of two electric motors with fixedly mounted propellers. Longitudinal here refers to the thrust vector, which extends substantially parallel to the body-fixed longitudinal axis 115. In hovering flight, the longitudinal axis 115 is oriented approximately vertically in space; in cruise flight, the longitudinal axis 115 is oriented substantially horizontally with respect to the earth's gravitational pull. Exemplarily, the longitudinal drive units 104 are mounted on or above the wing 102, generating higher lift and attenuating downward noise emissions, thereby allowing the hybrid drone to appear nearly silent relative to the ground during cruise flight.

By way of example, longitudinal drive units 104 are mounted fixed in this position. In another embodiment, these may be mounted to tilt or pivot about any axis, or may be moved to a longitudinal position via tilting wings, pivoting wings, lever arms, or other means. FIG. 2 shows another position for two longitudinal drive units 204 by way of example.

A drive unit can be a propeller drive with open, adjustable or enclosed propellers (=so-called impellers) or similar, as well as a turbine drive, a rocket drive or other thrust-generating variants that are generated electrically or chemically.

In a preferred embodiment, the longitudinal drive units 104 are designed with protected, shrouded electric thrusters, so-called impellers, so that the rotating parts are not free-standing and, accordingly, the risk of injury is reduced in any situation. In addition, noise emission is significantly reduced.

By way of example, a high drive unit 105 is shown in FIG. 1a. High refers to the high thrust vector, which is substantially parallel to the high axis 116, which is orthogonal to the longitudinal 115 and transverse 117 axes. The high drive units 105 or 205 are not necessarily mounted fixed in this position, but can also be mounted tiltable or pivotable about any axis, or can be brought into a high drive position by means of tilting wings, pivoting wings, lever arms or other aids.

In order to perform a rolling motion about the longitudinal axis 115, the hybrid drone, exemplarily shown in FIG. 1a, may include at least one tail fin having tail control surfaces 108, wherein the tail fin is arranged above the at least one wing 102 and behind the wing 102 by a support element 109 connected to at least one of the wing 102 or the fuselage part 113. In addition, at least one tail control surface 108 is disposed in an airflow 120 that can be generated by the first and/or second longitudinal drive units 104. Thus, the rolling motion of the hybrid drone in slow flight is accomplished by means of differential actuation of the tail control surfaces 108.

In fast forward flight, the tail control surfaces 108 are significantly responsible for pitching about the lateral axis 117. In case of e.g. failure of the tail control surfaces 108, the high drive unit 105 can take over the generation of the pitch. According to the invention, in slow flight or hovering flight, due to the high drive unit 105 being independent of airflow, it takes over significantly the generation of the pitching motion, In addition, in hovering flight, the tail control surfaces 108 can support the generation of the pitching motion or take over in case of failure, When loaded with an object 124, the center of gravity 107 changes especially along the vertical axis 116. The high drive unit 105 is dimensioned in such a way that the leverage force acting on the center of gravity 107 at full thrust of the longitudinal drive units 104 can be largely compensated by the high drive unit 105 and, moreover, a wide variety of centers of gravity due to a wide variety of masses of objects 124 can be compensated.

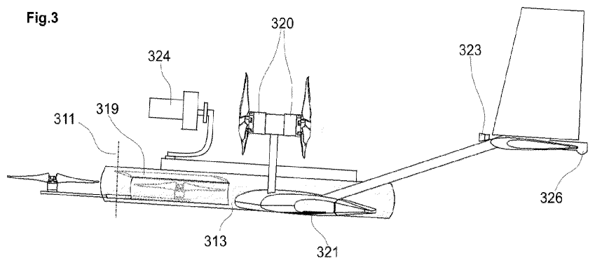

In one embodiment illustrated in FIG. 3, at least the first high drive unit is pivotable about a pivot axis 311, wherein the pivot axis 311 extends substantially orthogonally to the longitudinal axis 115. In this regard, at least the first high drive unit 105 is mounted on a pivotable or extendable arm and is retractable into the fuselage part 113 or wind 102, FIG. 3 illustrates a flap 319 which opens prior to retraction or extension and aerodynamically favorably conceals a retracted high drive unit 105 in the fuselage part 313.

In a further embodiment, the hybrid drone has at least a second high drive unit 205, wherein the second high drive unit 205 is aligned or can be pivoted, tilted or rotated about any axis in such a way that a high thrust force that can be generated by means of the high drive unit 205 acts downward or upward substantially orthogonally to the longitudinal direction 106 and is mounted with a defined lever distance relative to the center of gravity 107 of the hybrid drone. FIG. 2 shows an example of a version with two high drive units 205. With two high drive units 205 located in front of the center of gravity, not only the pitch motion but also the roll motion can be controlled in hovering flight, by differential control of the first and the second high drive unit 205.

In another embodiment, shown in FIG. 3, the hybrid drone has a third and a fourth longitudinal drive unit 320, wherein the third is coaxial with the first longitudinal drive unit 320 and the fourth is coaxial with the second longitudinal drive unit 320. Thus, the rolling motion can be performed via differential control of the longitudinal drive units 104 in such a way that two drive units rotating in the same direction have a higher rotational speed than the two drive units rotating in opposite directions. Due to the generation of a torque, a roiling motion is initiated.

In another embodiment of the hybrid drone, at least one of the longitudinal drive units 104 and/or at least one first high drive unit 105 is configured and/or controllable to reverse thrust by changing the direction of rotation or by blade pitch. The detailed explanation for this feature is described in the method.

FIG. 1b shows an example of an object 124 as a package in the form of a folding box. In further embodiments, the object 124 may take on a wide variety of sizes and shapes. In this regard, the object 124 may include power consuming components that are powered by the power source of the hybrid drone via the object-holding device 110 that provide power to the integrated systems for cooling, heating, or other functions, for example. In another embodiment, the object 124 may include an additional voltage source and provide additional power to the hybrid drone for longer ranges. In another embodiment, shown in FIG. 3, the object 324 includes additional sensors, such as a high-resolution camera for measuring ground conditions or the like. In this case, a data link is established in addition to the power supply, allowing the object 324 to be controlled by the hybrid drone.

For transporting objects 124, an object-holding device 110 is provided according to the invention, which is arranged at an upper side or at a lower side between the first and the second longitudinal drive units 104 (with respect to the transverse axis, in an area defined by two planes, perpendicular to the transverse axis and wherein the intersection of one plane with the transverse axis is defined by the arrangement of the first longitudinal drive unit and the intersection of the other plane with the transverse axis is defined by the arrangement of the second longitudinal drive unit along the transverse axis) and configured to accommodate an object 124, wherein the underside of the hybrid drone is below the at least one wing 102 and the upper side is above the at least one wing 102. In FIG. 2, an object 224 is mounted below as an example.

In further embodiments, the object-holding device 110 may also include an interface for a discharge current and/or charge current and/or a unidirectional or bidirectional data link for accommodating objects 324 with power consumption or a power source or a wide variety of sensors.

The object-holding device 110 in a conveyor system 119 configured to convey an object 124 received by the object-holding device 110 forwardly or rearwardly, particularly to convey the object 124 forwardly or rearwardly of the wing 102 and eject it forwardly or rearwardly of the wing 102 or to change the center of gravity 107 during a flight.

In accordance with the invention, the transport system 119 can transport objects 124 of different weights and move them during flight so as to move the center of gravity 107 from the object 124 to the optimal position for flight performance.

FIG. 1c shows an exemplary method of dropping the object 124 with a small parachute 190 behind the hybrid drone that is in cruise flight. In this process, a parachute 190 integrated in the object 124′ is released via the data link of the object-holding device 110. After the parachute 190 is successfully deployed and the object 124′ reaches the desired drop point, the object 124′ is released from the object-holding device 110 and the object 124 is pulled backward by the braking force of the parachute 190.

FIG. 1b illustrates a method of unloading the object 124 by conveying the object 124 over the top end of the vertical receiving structure. The hybrid drone has successfully hooked onto a top-ending vertical structure, illustrated by a balcony 132. Here, exemplified with the aid of a rotatably mounted 134 transport system 119, this is brought to a horizontal level by a power cylinder 131. The conveyor system 119 subsequently pushes the object 124 forward until it tips over the front edge of the conveyor system 119.

Vertical structure in this case refers in particular to a balcony or its railing or parapet, windows, house facades, steeper gable roofs or the like and is accordingly to be understood in particular as substantially vertical to the earth's gravitational pull. In addition, a launching and landing station in a mounted state is also to be understood as a vertical structure, the launching and landing station being mounted parallel thereto, for example. According to the invention, a landing approach of a drone to a vertical structure can be performed very quietly and also for relatively narrow urban canyons. This increases the target audience for a drone package delivery and also enables deliveries at quiet times, such as at night. For example, all that is needed is a balcony, a window, a steeper pitched roof, and/or access to a house facade, unlike other concepts that require open spaces or flat roofs. In addition, third parties have no access to the package or the drone and reliable delivery can thus be guaranteed.

The hybrid drone according to the invention is equipped with at least one holding element, in particular hook 112, which is associated with the underside of the hybrid drone, wherein the holding element is designed for releasably arranging, in particular for hooking, the hybrid drone on a top-ending vertical receiving structure.

The holding element has an opening in a holding direction opposite to the longitudinal direction 106, in particular the holding element has a structure that is pronounced towards the rear and accessible from the rear. This is not to be contused with a so-called arresting hook, which is open in the longitudinal direction 106 to abruptly slow down the speed of an unmanned aerial vehicle.

This holding element is designed to be fixed or extendable, in particular retractable into the fuselage or wing 102.

The holding element may be configured to generate a holding force by pressing the hybrid drone against the vertical structure, in particular by partially retracting the holding element.

In addition, the hybrid drone of FIG. 1 or 1b includes a counter element 114 extendable at the underside for applying a clamping force between the holding element 112 and the counter element 114. FIG. 1b illustrates such clamping with a balcony 132, wherein the hook 112 grips around a balcony railing 132 and a counter element 114 generates a clamping force.

In one embodiment, the hybrid drone has an adhesive strip 321 on the underside of the hybrid drone for forming a releasable adhesive connection with a mating adhesive element 401 disposed on the vertical receiving structure.

This adhesive strip 321 may be attached to the underside of the wing 102, or to the underside of a structure similar to a landing gear 207, so that upon contact with a vertical structure, a holding force is immediately generated and rebound can be prevented. The size of the adhesive strip 321 is such that the adhesive connection will hold the entire weight of the hybrid drone and a safety factor in place.

Adhesive strips 321 may be Velcro strips, magnetic strips, adhesive strips, or the like.

The hybrid drone according to the invention, as illustrated in FIG. 1d, has an object release device 118 with at least two release elements 150 connectable to the object 124 separated by a distance 151 of at least 10 cm, in particular ropes or cables.

Thus, when hovering over the release location, the hybrid drone can release an object 124 in a coordinated manner via at least these two object release devices 118. The object 124 is rotated in a desired direction relative to a longitudinal object axis 154, particularly in a wind direction, during the release process. The object 124 is further held in a desired position about an object vertical axis 152 by the two release elements 150 during the release process regardless of the position of the hybrid drone, in particular in a position parallel to the ground. At a certain distance from the ground or when contact is made by the object 124 on the ground, a release mechanism disconnects the connection in a coordinated manner between the two release elements 150 and the object 124.

In a further embodiment, the hybrid drone has a control unit that has a release functionality, in the execution of which the object release device 118 and/or the drive units are controlled in such a way that the object 124 is set into a defined oscillating or swinging motion and a targeted release of the object 124 at a specific point of the oscillating or swinging motion takes place.

Because of the two object release devices 118, greater stability about the transverse axis 117 is provided and contact with or damage to the tail fin during lowering under high crosswind conditions can be avoided.

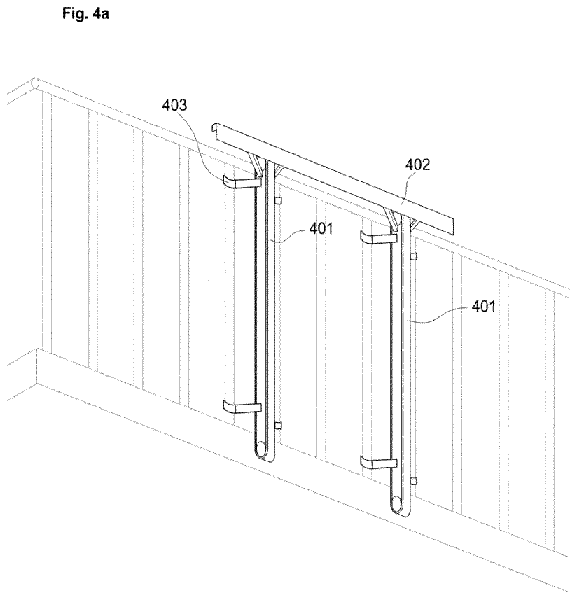

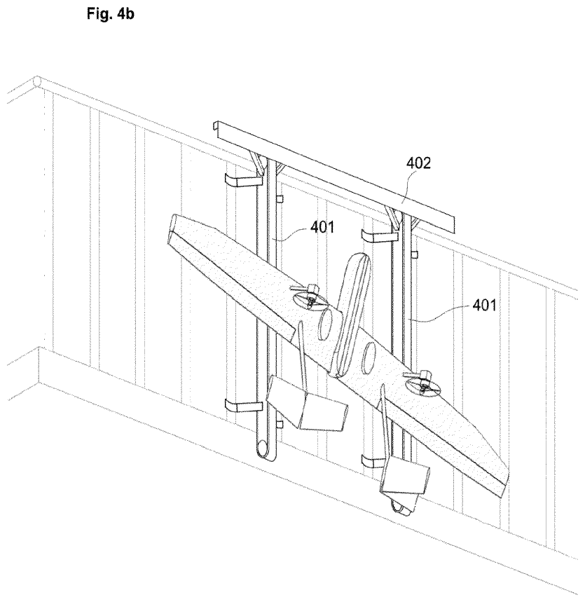

FIG. 4a shows the vertical launching and landing device for a hybrid drone according to the invention. This includes an attachment device 403 configured to attach the launching and landing device to a structure in a substantially vertical orientation, in particular to a vertical side of the structure. The launching and landing device comprises: at least one conveyor drive, at least two contact and guide elements, which are formed parallel to each other with a certain spacing, wherein each of the contact and guide elements comprises a mating adhesive element 401 for establishing a releasable adhesive connection with the adhesion element of the hybrid drone and the mating adhesive elements 401 are formed in a belt-like manner and are drivable in a circulating manner by means of the conveyor drive, in particular in a conveyor belt-like manner, in such a manner that a hybrid drone according to the invention, which is present in adhesive connection, can be moved in a controlled manner along the contact and guide elements.

A further embodiment of the vertical launching and landing device includes two conveyor drives, which make each of the mating adhesive elements 401 individually drivable by means of one of the conveyor drives in each case, and wherein a hybrid drone present in adhesive connection can be aligned with respect to its horizontal orientation by differential driving of the mating adhesive elements 401.

In very high crosswind conditions, the hybrid drone according to the invention, rotated about the vertical axis 116, leans into the wind to prevent it from drifting away from the wind. The drone according to the invention can maintain this position until “docking” with the launching and landing device illustrated in FIG. 4b. Due to a communication link, the hybrid drone according to the invention gives a command for the differential control of the conveyor belts, whereby the hybrid drone is raised horizontally again illustrated in FIG. 4c.

Typically, the mating adhesive elements 401 of the launching and landing station are Velcro, with the corresponding adhesive element on the hybrid drone then being the other element of the Velcro side. Other adhesive and mating adhesive elements are possible.

The vertical launching and landing device further includes at least one repulsion element 402 for repulsion of a hybrid drone disposed on the launching and landing device, in particular for creating or increasing an angle between the vertical orientation of the launching and landing device and the longitudinal direction 106 of the drone.

Optionally, the launching and landing device also has a docking station. This provides charging current and/or unidirectional or bidirectional data traffic. An interface of the docking station is adapted to a corresponding—also optional—interface of the drone 1, i.e. the interface can be plug- or cable-based or wireless (inductive charging, NFC, Bluetooth, WiFi, etc.).

Hybrid drones can take a wide variety of forms. A drone is commonly known as an unmanned aerial vehicle, unmanned aerial system or unmanned aerial vehicle. This can be controlled autonomously or semi-autonomously. Semi-autonomous means only limited maneuvers without the physical presence of a human. For example, parts of a flight may be controlled remotely by a pilot and other parts of a flight are performed autonomously. Typically, but not necessarily, a remotely controlled pilot can switch an autonomously flying drone to direct control inputs at any time. Furthermore, different semi-autonomous stages may be present where a remotely controlled pilot only specifies navigation points and these are then flown by the drone in a straight line or based on autonomous decisions such as avoiding obstacles, keeping to flight zones or the like on a non-straight line flight path. Many other examples are possible.

A hybrid drone specifies an unmanned aerial vehicle having at least one wing 102, which typically has the ability to take off and land vertically.

These hybrid drones can include a wide variety of embodiments and are most commonly categorized as convertiplane and tail launchers. A convertiplane keeps the main body of the aircraft substantially stable in a pitch attitude during all flight modes, and certain transitions or turning mechanisms are applied to change flight modes. Tail launchers take off and land on the majority of the tail, and the entire hybrid drone rotates to aim for a horizontal cruise.

One embodiment of a convertiplane is equipped with a tilt rotor in which multiple rotors are mounted on a rotatable nacelle. During the transition from hover to cruise, all or some of the rotors rotate in the direction of cruise. In bi-rotor configurations, the nacelles are usually mounted on a wingtip. At the same time, these configurations usually have rotors with a swashplate that allows collective pitch and cyclic pitch. Tri-rotor or quad-rotor configurations are usually equipped with fixed propellers. Other tilt rotor variants are possible.

Another embodiment of a convertiplane is equipped with a tilting wing, illustrated in FIG. 9, in which part or all of the wing or wings, each including the drive units, is rotated or tilted during a transition to another flight mode. The center section remains substantially horizontal. Other tilt-wing and combinations with tilt-rotor variants are possible.

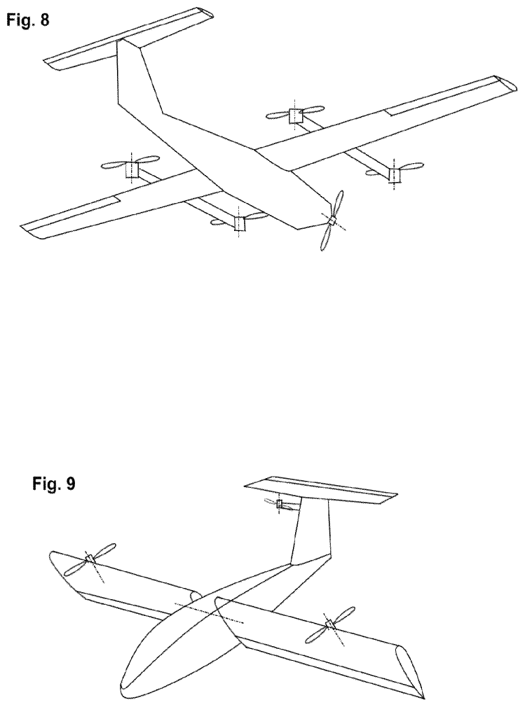

Another embodiment of a convertiplane is equipped with dual system, illustrated in FIG. 8. This version consists of a combination of at least two drive systems, one drive system with several drive units arranged symmetrically through the center of gravity is for this purpose only for hovering flight and at least one drive unit arranged in longitudinal direction is only for cruise flight. Accordingly, a tilting mechanism is not necessary. In cruise flight, the drive units required for hovering flight are switched off, partially switched off or switched on and can provide additional lift alongside the wing. Typically, these high drive units produce great drag, generate many vortices, and are accordingly relatively noisy in cruise flight. Special variants such as retracting and extending wings or similar are possible.

Another embodiment of a convertiplane is equipped with a rotor wing. Rotor wings or stop rotors are subsequently a special variant of a hybrid drone, which rotates one or more wings in hovering flight and stops the rotation of the wing in a transition, wherein at least one wing is rotated by almost 180° and accordingly all wings are oriented in cruise direction and provide lift for the cruise flight.

Another embodiment of a tail launcher is provided with a longitudinal mono thrust drive unit 106. This drive unit is mounted longitudinally 106 of the hybrid drone and usually at the very front or rear of the tail. The transition from hover to cruise is usually generated by vectoring the thrust due to fan blades, cyclic or variable pitch blades, or a moveably mounted drive unit.

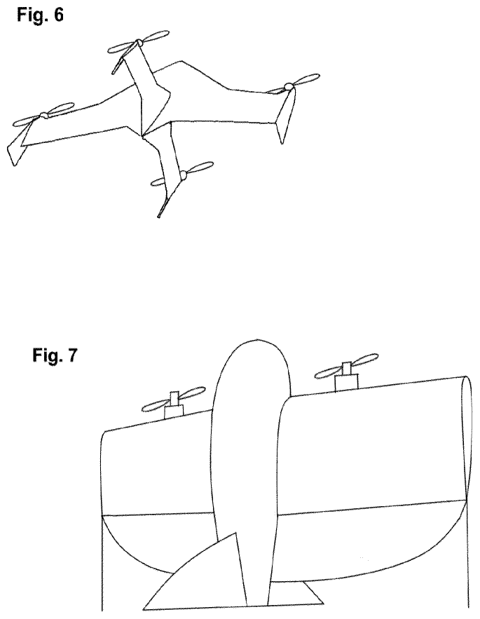

Another embodiment of a tail launcher is equipped with one or more drive units in the longitudinal direction 106 with collective thrust, as illustrated in FIG. 7, wherein the control surfaces are in the airflow of the drive unit or drive units at which the thrust is collectively increased or decreased.

The property of transporting objects 124 is very limited in a mono thrust or collective thrust variant, since no large center of gravity changes in a defined vertical axis 116 can be compensated.

Tail launchers with differential thrust control, as illustrated in FIG. 6, are equipped with drive units arranged in the longitudinal direction 106. The arrangement and control is very similar to multicopter configurations, particularly guadrocopters, hexacopters, octocopters or the like. In this case, yaw, pitch and roll is achieved by the differential speed change of the individual motors. A climb and descent is controlled in hovering flight by collectively reducing or increasing the speed. The advantage of differential thrust control is that no wing control surfaces are required and generally there are very few rotating parts. To increase yaw about the vertical axis 116, the engines are usually not mounted exactly in the longitudinal direction 106, but tilted about an axis passing through the center of gravity 107, depending on the direction of rotation of the propellers. This helps especially for far out masses, for example when the wings are very far out from the center of gravity 107, for example to enclose the drive units and protect them.

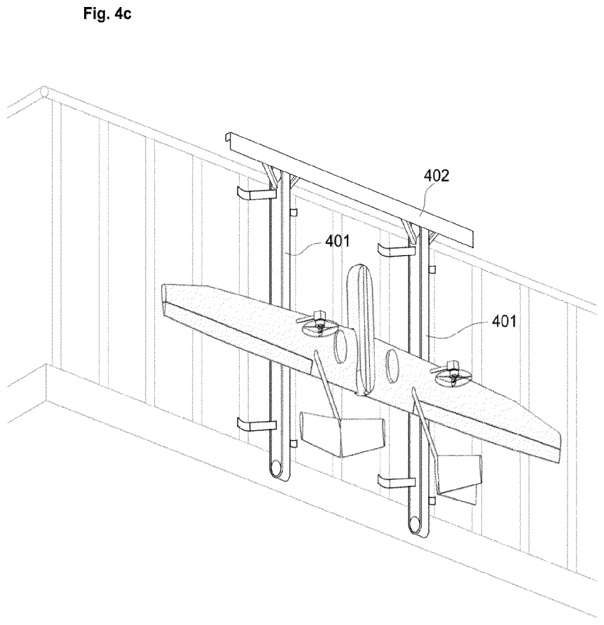

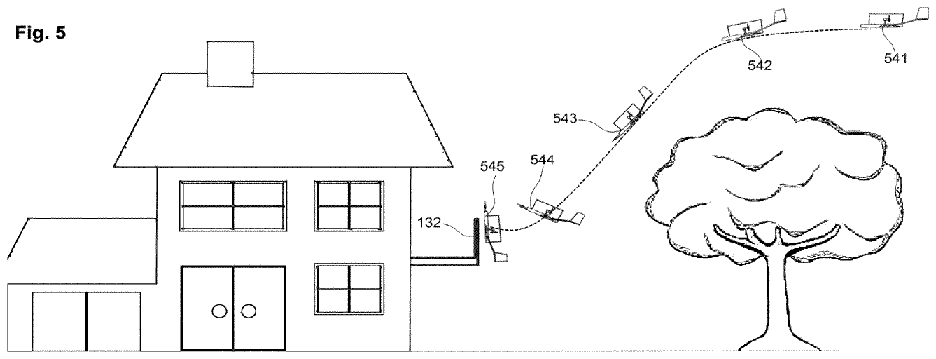

FIG. 5 shows an embodiment of a method for rapidly transitioning the hybrid drone according to the invention from a cruise flight state 541 to a hovering flight state 545, wherein a main direction of motion of the hybrid drone in the cruise flight state corresponds to a horizontal direction, a main lift is generated by air flowing around the at least one first wing 102, and the longitudinal drive units 104 generate a forward thrust in the longitudinal direction 106.

The following method is used: (a) Initiating a descent by a forward pitch 542 of the hybrid drone. (b) Reducing or terminating the thrust of the longitudinal drive units 104, as illustrated at 543, in particular generating a thrust reversal, to reduce the speed of movement of the hybrid drone. (c) Generating a thrust substantially orthogonally to the longitudinal direction 106 by means of the high drive unit 105 to accelerate or decelerate a pitching motion 544 of the hybrid drone such that the hybrid drone is displaced to a substantially vertical orientation, in particular the longitudinal direction 106 is substantially vertically oriented. (d) Upon reaching the vertical orientation or a hovering flight state 545, such a regulated adjustment of the thrust in the longitudinal direction 106 depending on a total weight of the hybrid drone, in particular taking into account a transported object 124, that the speed of movement of the hybrid drone in the longitudinal direction 106 is substantially 0. (e) In the hovering flight state, a continuous regulation, in particular holding, of the vertical orientation of the hybrid drone is provided by means of regulating the high drive unit(s).

With this method, the transition to hovering flight occurs very quickly and in a very small space compared to the known methods of a tail launch, where the process can only occur slowly due to abrupt aerodynamic forces of the wing 102, such as from a stall. Due to the low speed during the upward pitch of the hybrid drone according to the invention, negligible aerodynamic forces of the wing 102 are generated. Thus, the hybrid drone can approach balconies or windows in narrow urban canyons or over obstacles in the approach area with a very steep nearly vertical approach angle. Thus, it is also possible to approach a vertical structure laterally or at an angle, and once in a hovering flight state, perform a roll about the longitudinal axis 115 and then continue the approach to the vertical structure.

Provided that the center of gravity 107 is in front of the longitudinal drive unit, hovering flight is an unstable flight attitude. The regulating unit nevertheless keeps the hybrid drone constantly in an upright position.

Depositing an object 124 transported by the hybrid drone comprises the steps of: (a) Approaching the hybrid drone to a top-ending vertical receiving structure by generating a pitching motion of the hybrid drone, in particular setting a defined angle of the longitudinal direction 106 relative to the vertical, and thereby generating a relative motion of the hybrid drone towards the vertical receiving structure. (b) Providing contact of the hybrid drone and the vertical receiving structure by the continuous approach. (c) Ascending the hybrid drone along the vertical receiving structure until at least the holding element is provided in the vertical direction above the upper end of the vertical receiving structure. (d) Aligning the holding element in such a way that a part of the holding element designed for releasable arrangement is present above the top-ending vertical receiving structure. (e) Arranging, in particular hooking, the hybrid drone to the vertical receiving structure by lowering the hybrid drone by reducing the thrust in the longitudinal direction 106 while maintaining contact with the vertical receiving structure.

In one embodiment, as shown in FIG. 5, the vertical receiving structure is sensed and detected in an attitude of the hybrid drone at 543 by, for example, image processing, lidar, or radar, and initiation of reduction or termination of thrust of the longitudinal drive units 104 is accomplished in response to detection of the vertical receiving structure.

Furthermore, the vertical receiving structure is detected and recognized in the position 544 and 545, in particular by means of image processing, lidar or radar, and the approaching and/or arranging of the hybrid drone is carried out in dependence on the recognition of the vertical receiving structure.

Contact with the vertical receiving structure, such as a balcony 132, occurs well below the edge of the top-ending vertical structure, where people on the balcony 132 cannot come in close proximity to the landing hybrid drone. Due to the large area for contact at the vertical receiving structure, landings can be performed even at high wind speeds.

In one embodiment, the holding element is fixedly mounted and thus the hybrid drone does not rest flat on the vertical receiving structure, As soon as the holding dement extends beyond the top-ending vertical structure, the drone pitches in the direction of the vertical receiving structure. In another embodiment, the holding element is retracted into a wing 102 or fuselage and the drone rests flat on the vertical receiving structure. As soon as the drone extends beyond the top-ending vertical structure, the holding element extends.

After descending onto a top-ending vertical structure as part of hooking the hybrid drone, in another aspect illustrated in FIG. 4, a clamping force is generated by partially retracting the holding element 112 or generating a counterforce by a counter element 114.

A launching method for putting a hybrid drone, which is in vertical orientation and arranged at the top-ending vertical receiving structure, into a cruise flight state, comprises the following steps: (a) Detaching the hybrid drone from the vertical receiving structure by generating a thrust force in the longitudinal direction 106, in particular by means of the longitudinal drive units 104. (b) Generating a thrust force substantially orthogonally to the longitudinal direction 106, in particular by means of the high drive unit, whereby a tilting, in particular pitching, of the hybrid drone in direction away from the vertical receiving structure occurs. (c) Regulating the thrust force in longitudinal direction 106 and the thrust force substantially orthogonally to the longitudinal direction 106 such that the hybrid drone is provided in a hovering flight state with a horizontal direction of movement away from the vertical receiving structure. (d) Increasing the thrust in the longitudinal direction 106 upon reaching a predetermined distance from the vertical receiving structure. (e) Regulating the thrust force in the longitudinal direction 106 such that the hybrid drone is placed in a climb. (f) Generating a pitching motion of the hybrid drone upon reaching a certain altitude and shifting the hybrid drone from the climbing flight to the substantially horizontal cruise flight state.

In an extended method, starting at a certain distance from the vertical structure, before (d) increasing the thrust force in the longitudinal direction 106, the thrust force substantially orthogonal to the longitudinal direction 106 is changed, in particular by reducing the thrust force or reversing the thrust of the high drive unit, causing the hybrid drone to tilt back.

This method prevents collisions with any protruding objects such as extended awnings, clothes racks, attachments or the like.

Furthermore, in another aspect, the at least one high drive unit 105 is retracted after reaching the cruise flight state.

A further method of launching a hybrid drone, which is in a horizontal orientation and rests on its underside, into a cruise flight state, comprising the following steps: (a) Generating a thrust force substantially parallel to the vertical axis 116, in particular by means of the high drive unit, thereby causing the hybrid drone to straighten in the direction of a vertical orientation of the longitudinal direction 106. (b) In particular, balancing the hybrid drone in the vertical orientation. (c) Generating a thrust force in the longitudinal direction 106, in particular by means of the longitudinal drive units 104, causing the hybrid drone to take off. (d) Regulating the thrust force in the longitudinal direction 106 such that the hybrid drone is placed in a climbing flight. (e) Generating a pitching motion of the hybrid drone upon reaching a certain altitude and shifting the hybrid drone from the climbing flight to the substantially horizontal cruise flight state.

A hybrid drone may have various types of sensors and sufficient computing capacity to perform the functions as described herein. These typically include an inertial navigation system (e.g., IMU, gyro sensor), GNSS, sonar sensors, image sensors, and others.

Furthermore, a hybrid drone may have multiple processors that can read and execute a computer program that is stored on a data storage device.

The regulating unit can combine all the components or processes just described and, based on the incoming sensor data, calculate and generate the control signals for the hybrid drone according to the invention via processors using a computer program available on a data storage device.

Inertial navigation systems or IMUs usually combine accelerometers and gyro sensors. In this case, accelerometers can determine the orientation of the hybrid drone with respect to the earth, and gyro sensors measure the rate of rotation about all three axes. These inertial sensors are now available cheaply and in very small form, specifically in the form of Micro Electro Mechanical Systems (MEMS) or in Nano Electro Mechanical Systems (NEMS). In most cases, air pressure sensors and magnetometers are also incorporated into an IMU to improve the accuracy of an attitude determination.

The position determination of the drone is usually determined with receivers for the global navigation satellite system (GNSS), which receives only one or various providers such as NAVSTAR GPS, GLONASS, Galileo or others. Sensor fusion calculation of the IMU and other sensors, such as sonar sensors or image sensors, can further increase the accuracy of the position determination.

The hybrid drone according to the invention may comprise a detection system, in particular cameras 323, lidar or radar, which is configured to perform object detection, wherein the regulating unit is configured to control the hybrid drone based on the object detection.

Furthermore, the hybrid drone according to the invention may comprise a sensor 135 for detecting a distance between the hybrid drone and the vertical receiving structure, in particular wherein the sensor 135 is arranged at the bottom.

Preferably, the hybrid drone may be equipped with multiple small cameras 323 (as part of the acquisition system) to detect and avoid other flying objects, to accurately fly the landing, to check for obstacles prior to takeoff, to check for proper mounting from the object 124, to scan barcodes on the object 124, and to observe the object 124 during flight.

While the invention has been explained in terms of its preferred embodiment(s), many other changes and variations can be made without going beyond the scope of the present invention. Therefore, it is intended that the appended claims cover changes and variations included in the actual scope of the invention.

1. a hybrid drone, comprising
at least one first wing having an airfoil, in particular having a wing control surface, wherein a drone-own transverse axis is defined by an extension of the at least one wing,
at least a first and a second longitudinal drive unit, wherein
the first longitudinal drive unit and the second longitudinal drive unit are arranged on the at least one wing, and
the first and second longitudinal drive units are each aligned or pivotally alignable such that a thrust force that can be generated by the respective longitudinal drive unit acts parallel to a longitudinal direction of the hybrid drone, wherein the longitudinal direction is orthogonal to the transverse axis and directed substantially in a forward flight direction defined by the hybrid drone,
an object-holding device formed on an upper side or on a lower side between the first and second longitudinal drive units and for holding an object, wherein the lower side of the hybrid drone is below the at least one wing and the upper side is above the at least one wing,
a regulating unit which is designed to regulate the hybrid drone, in particular the drive units, based on control signals,
wherein the hybrid drone has
at least one first high drive unit, wherein
the first high drive unit is aligned or can be pivotally aligned in such a way that a thrust force which can be generated by the high drive unit acts substantially orthogonally to the longitudinal direction and substantially parallel to a vertical axis of the hybrid drone, and
the first high drive unit is arranged with a defined lever spacing relative to a center of gravity of the hybrid drone,
and wherein by the first high drive unit a pitch angle of the hybrid drone is adjustable in the flight state, and
at least one holding element, in particular hook, which is associated with the underside in a front region of the hybrid drone, wherein the holding element is designed for releasable arrangement, in particular for hooking, of the hybrid drone on a top-ending vertical receiving structure.

2. The hybrid drone according to claim 1, wherein
the holding element is arranged on the at least one wing or
the hybrid drone further comprises a fuselage part (113), and the holding element is arranged on the fuselage part (113).

3. The hybrid drone according to claim 1, wherein the holding element comprises an opening in a holding direction opposite to the longitudinal direction, in particular wherein the holding element comprises a rearwardly protruding structure accessible from the rear.

4. The hybrid drone according to claim 1, wherein the holding element is fixedly mounted or is designed to be extendable and/or retractable, in particular in the at least one wing or a fuselage part.

5. The hybrid drone according to claim 1, wherein the holding element is designed to generate a holding force by pressing the hybrid drone against the vertical structure, in particular by partially retracting the holding element.

6. The hybrid drone according to claim 1, wherein the hybrid drone comprises a counter element extendable at the underside for applying a clamping force between the holding element and the counter element.

7. The hybrid drone according to claim 1, wherein the hybrid drone comprises at least one tail fin with tail control surfaces, wherein the tail fin is arranged above the at least one wing and behind the wing by a support element connected to the at least one wing, in particular the fuselage part, and wherein the at least one tail fin is arranged in an airflow that can be generated by the first and/or the second longitudinal drive units.

8. The hybrid drone according to claim 1, wherein the hybrid drone comprises at least one second high drive unit, wherein
the second high drive unit is aligned or can be pivotally aligned such that a thrust force that can be generated by the high drive unit acts substantially parallel to the vertical axis, and
the second high drive unit is mounted with a defined lever distance relative to the center of gravity of the hybrid drone,
and wherein a pitch angle and roll angle can be adjusted in the light state by the second high drive unit.

9. The hybrid drone according to claim 8, wherein a rolling motion of the hybrid drone in slow flight is controllable by differential control of the tail control surfaces and/or by differential control of the first and the second high drive units.

10. The hybrid drone according to claim 1, wherein at least the first high drive unit is pivotable about a pivot axis wherein the pivot axis extends substantially orthogonally to the longitudinal direction and substantially orthogonally to the transverse axis.

11. The hybrid drone according to claim 1, wherein the at least first high drive unit is mounted on a pivotable or extendable arm and is retractable in the at least one wing, or in particular in a fuselage part.

12. The hybrid drone according to claim 1, wherein the object-holding device comprises a conveyor system adapted to convey an object received by the object-holding device forwardly or rearwardly, in particular to convey the object forwardly or rearwardly of the wing and eject it forwardly or rearwardly of the wing or to change the center of gravity during a flight.

13. The hybrid drone according to claim 1, wherein at least one of the longitudinal drive units and/or the at least one first high drive unit comprises an electrically powered motor and propeller and/or enclosed propeller, in particular impeller.

14. The hybrid drone according to claim 1, wherein at least one of the longitudinal drive units and/or the at least one first high drive unit is designed and/or controllable for thrust reversal by changing the direction of rotation or by blade pitch.

15. The hybrid drone according to claim 1, wherein the hybrid drone further comprises a third and a fourth longitudinal drive unit, wherein the third longitudinal drive unit is arranged coaxially with the first longitudinal drive unit and the fourth longitudinal drive unit is arranged coaxially with the second longitudinal drive unit.

16. The hybrid drone according to claim 1, wherein the hybrid drone further comprises an adhesive strip on an underside of the hybrid drone for establishing a releasable adhesive connection with a mating adhesive element arranged on the vertical receiving structure.

17. The hybrid drone according to claim 1, wherein the hybrid drone further comprises a detection system, in particular camera, lidar or radar, which is designed for object detection, wherein the regulating unit is designed for controlling the hybrid drone based on the object detection.

18. The hybrid drone according to claim 1, wherein the hybrid drone further comprises an object release device having at least two release elements, in particular ropes or cables, which can be connected to the object, wherein the release elements have a spacing of at least 10 cm.

19. The hybrid drone according to claim 18, wherein the hybrid drone further comprises a control unit that has a release functionality, in the performance of which a control of the object release device and/or of the drive units takes place in such a way that the object is set into a defined pendulum or swinging movement and a targeted setting down of the object takes place at a specific point of the pendulum or swinging movement.

20. The hybrid drone according to claim 1, wherein the hybrid drone further comprises a sensor for detecting a distance between the hybrid drone and the vertical receiving structure, in particular wherein the sensor is arranged on the underside.

21. A method for operating a hybrid drone, wherein a main direction of movement of the hybrid drone in a cruise flight state corresponds to a horizontal direction, a main lift is generated by flowing around at least one first wing, and one or more longitudinal drive units generate a forward thrust in a longitudinal direction comprising
initiating a descent by a forward nod of the hybrid drone,
reducing or terminating the forward thrust of the longitudinal drive units, in particular generating a thrust reversal, to reduce the speed of movement of the hybrid drone,
generating a thrust force substantially orthogonal to the longitudinal direction by the high drive unit for initiating, accelerating or decelerating a pitching motion of the hybrid drone in such a way that the hybrid drone is displaced into a substantially vertical orientation, in particular the longitudinal direction is oriented substantially vertically, and
when reaching vertical orientation
such a regulated adjustment of the forward thrust in the longitudinal direction depending on a total weight of the hybrid drone, in particular taking into account a transported object, that the speed of movement of the hybrid drone in the longitudinal direction is substantially 0, and
continuous regulation, in particular holding, of the vertical orientation of the hybrid drone by regulation of the high drive unit, so that the hybrid drone is provided in the hovering flight state.

22. The method according to claim 21, further comprising detecting and recognizing, in particular by image processing, lidar or radar, a vertical receiving structure and initiating the reduction or termination of the forward thrust depending on the recognition of the vertical receiving structure.

23. The method of claim 21 further comprising:
approaching the hybrid drone to a top-ending vertical receiving structure by generating a pitching movement of the hybrid drone, in particular setting a defined angle of the longitudinal direction relative to the vertical, and thereby generating a relative movement of the hybrid drone in the direction towards the vertical receiving structure.
providing a contact of hybrid drone and vertical receiving structure through the continuous approach.
ascending the hybrid drone along the vertical receiving structure until at least the holding element is provided in the vertical direction above the upper end of the vertical receiving structure,
aligning the holding element in such a way that a part of the holding element designed for releasable arrangement is present above the top-ending vertical receiving structure,
arranging, in particular hooking, the hybrid drone to the vertical receiving structure by lowering the hybrid drone by reducing the forward thrust in the longitudinal direction while maintaining contact with the vertical receiving structure.

24. The method according to claim 23, wherein the orientation of the holding element is performed by extending the holding element and/or by pitching the drone in the direction of the vertical receiving structure.

25. The method according to claim 23, wherein in the course of arranging the hybrid drone, the generation of a clamping force is performed by partially retracting the holding element or generating a counterforce.

26. The method according to claim 23, further comprising unloading the object by conveying the object over the top of the vertical receiving structure.

27. The method according to claim 23, further comprising detecting and recognizing, in particular by image processing, lidar or radar, the vertical receiving structure and approaching and/or arranging the hybrid drone depending on the recognition of the vertical receiving structure.

28. A method for operating a hybrid drone comprising
generating a thrust force substantially parallel to a vertical axis, in particular by a high drive unit, thereby causing the hybrid drone to straighten in a direction of a vertical orientation of a longitudinal direction,
in particular balancing the hybrid drone in the vertical orientation,
generating a thrust force in the longitudinal direction, in particular by one or more longitudinal drive units, causing the hybrid drone to take off,
regulating the thrust in the longitudinal direction such that the hybrid drone is placed in a climbing flight, and
generating a pitching motion of the hybrid drone upon reaching a certain altitude and shifting the hybrid drone from the climbing flight to a substantially horizontal cruise flight state.

29. A method for operating a hybrid drone comprising
detaching the hybrid drone from a vertical support structure by generating a thrust force a longitudinal direction, in particular by one or more longitudinal drive units,
generating a thrust force substantially orthogonally to the longitudinal direction, in particular by a high drive unit, causing tilting, in particular pitching, of the hybrid drone in a direction away from the vertical receiving structure,
regulating the thrust force in the longitudinal direction and the thrust force substantially orthogonally to the longitudinal direction such that the hybrid drone is provided in a hovering flight state with a horizontal direction of movement away from the vertical support structure,
increasing the thrust force in the longitudinal direction when reaching a certain distance from the vertical support structure,
regulating the thrust in the longitudinal direction in such a way that the hybrid drone is put into a climbing flight, and
generating a pitching motion of the hybrid drone upon reaching a certain altitude and shifting the hybrid drone from the climbing flight to a substantially horizontal cruise flight state.

30. The method according to claim 28, further comprising retracting the at least one high drive unit after reaching the cruise flight state.

31. The method according to claim 28, further comprising before increasing the thrust force in the longitudinal direction, the thrust force substantially orthogonal to the longitudinal direction is changed, in particular by reducing the thrust force or thrust reversal of the high drive unit, causing the hybrid drone to tilt back.

32. A launching and landing device comprising
an attachment device adapted to attach the launching and landing device to a structure in a substantially vertical orientation, particularly to a vertical side of the structure.
at least one conveyor drive and
at least two contact and guide elements, which are formed parallel to each other with a certain distance, wherein
each of the contact and guide elements comprises a mating adhesive element for establishing a releasable adhesive connection with the adhesive element of the hybrid drone, and
the mating adhesive elements are designed in the form of a belt and can be driven in rotation by the conveyor drive, in particular in the form of a conveyor belt, in such a way that a hybrid drone in adhesive connection can be moved in a controlled manner along the contact and guide elements.

33. The launching and landing device according to claim 32, wherein
the launching and landing device has two conveyor drives,
each of the mating adhesive elements can be driven individually one of the conveyor drives in each case,
a hybrid drone in adhesive connection can be aligned with respect to its horizontal orientation by differential driving of the mating adhesive elements.

34. The launching and landing device according to claim 32, wherein the mating adhesive elements are Velcro strips.

35. The launching and landing device according to claim 32, wherein the launching and landing device comprises at least one repulsion element for repulsion of a drone arranged on the launching and landing device, in particular for creating or increasing a distance between the adhesive element of the hybrid drone and the mating adhesive element.

36. A method for operating a hybrid drone, comprising
hovering the hybrid drone over a specific drop location,
dropping of an object connected to an object release device,
rotating the object in a certain direction, in particular in a current wind direction, during the release,
moving the object into a defined position, in particular into a position parallel to a ground, in particular horizontal position, and
releasing the connection between the object and the object release device when it touches the ground or reaches a certain distance from the ground.
